(19) United States
(12) Patent Application Publication
(10) Pub. No.: US 2010/0281703 A1
(43) Pub. Date: Nov. 11, 2010

(54) Try square

(76) Inventor: Christopher Vesper, Victoria (AU)

Correspondence Address: JACOBSON & JOHNSON, ONE WEST WATER STREET, SUITE 285, ST. PAUL, MN, 55107, US

(21) Appl. No.: 12/387,646

(22) Filed: May 5, 2009

(51) Int. Cl. B43L 7/00

(52) U.S. Cl. 33/480

(57) ABSTRACT

A try square with a blade extending perpendicularly from the stock and a pivotal tab housed at the end of the stock opposite the blade, the purpose of the tab being to lie within the stock when the square is put against surfaces to check if they lie at 90° and to project from the stock and lie coplanar with the blade during scribing. The projecting tab supports the stock during this operation.

### FIELD OF THE INVENTION

This invention concerns try squares in cabinet making, joinery, engineering and machining trades, gear shifts for gear boxes.

### BACKGROUND OF THE INVENTION

Marking out a job is exacting in that the operator must be watchful for defects in the timber available and blemishes in the synthetic boards and sheets at his disposal. The try square is the fundamental tool for ensuring the accurate layout of joints, the matching of boards and strips, the coincidence of lines. In even a simple job the square is handled frequently and any operator notices its weight, its centre of gravity, its temperature and its surface finish.

When used to test the angle of an internal corner of a piece, the edge of the square and the blade are offered up to the right angle and the truth or variation from 90° is noted. Similarly the truth of an external corner is tested by offering up the opposite edge of the square and the blade to the corner. The two surfaces of the piece to be tested must admit the full length of the handle and blade of the try square. Repairs and corrections such as cramping are sometimes preceded by checking the structural accuracy of the piece using a try square in the manner described.

Marking out can require a scriber pencil or marking knife and it is during this operation that the likelihood of error increases. When a joint position for example is marked on a wooden component, a mark is made at the meeting of the face and side. A marking knife incises the mark and the try square is laid in contact with the component with the edge of the handle in sliding contact with the side of the component. The blade lies across the face of the component. The square is slid toward the marking knife until the blade and knife touch. The handle and component are squeezed together with one hand while the other hand scribes across the component. When the components lie on the bench this is straightforward. The scribed line is continued around the component. The broader the blade the easier the square is to position on the component.

Much marking work is not as straightforward and attention must be paid to seating the handle snugly on the component. If the handle tilts, the blade rises from the component and the square's position is adjusted. Consequently most operators actively grasp the handle with one hand all the time it is in use.

U.S. Pat. No. 1,275,822 describes a cabinet makers square with a curved blade and a straight stock in which the blade pivots and is locked in a variety of angular positions. A fixed pin passes through the stock and projects on both sides of the stock so as to lie on the siding timber for which the square is designed. The intention is not to use this type of square to check the squareness of a job but for scribing profiled weather boards which were popular at the end of the nineteenth century. For example, the stock cannot be laid on a horizontal surface to check verticality of a furniture leg.

### SUMMARY OF THE INVENTION

The invention provides a try square comprising a straight stock with a pair of parallel edges, an upper face, a blade end and an opposite support end, a blade extending perpendicular from one of the parallel edges at the blade end of the stock, the blade having a top face and a bottom face, a tab housing at the opposite support end, a tab with a top face and a bottom face mounted in the housing and moveable from a stowed position clear of the parallel edge from which the blade projects to a support position alongside the blade in which the bottom face of the tab projects and lies coplanar with the bottom face of the blade so that both are operable to contact a common target surface, but the tab supports the stock as it rests on the target surface.

Preferably the tab housing is a cavity which opens on to the one parallel edge. The housing may instead be a rebate in one face of the stock.

The tab may be pivotally mounted in the housing and describes arcuate movement between the stowed position and the support position. In the shared position the tab is preferably not flush with the stock edge but just below.

The tab can be substantially rhomb shaped in plan. Alternative shapes are also suitable, namely triangular with rounded corners and quadrants. When the tab is quadrant the curved edge, the edge defines a pair of notches which are engaged by a detent carried in the stock adjacent the housing and the notches determine the projection of the tab. The tab need only pivot through 45° or so to project sufficiently to provide a stock support.

The tab may be elliptical or circular but eccentrically mounted. Instead of pivoting the tab may emerge and retract with linear motion from a slot in the stock. Instead of a cavity the tube could lie in a rebate in the face of the stock. These are mechanical equivalent.

In use the tab projects from the opposite support end when the tab is in the stowed position and is displaceable to the support position by finger pressure.

### BRIEF DESCRIPTION OF THE DRAWINGS

Certain embodiments are now described with reference to the accompanying drawings, in which:

FIG. 1 is a side view of the try square checking an external corner for squareness with the tab in the stowed position.

FIG. 2 is a plan of a fragment of the stock showing the tab in the support position.

FIG. 3 is a side view of the try square laid on a stile in the scribe position.

FIG. 4 is a plan of a fragment of the stock showing a variant with detents for the support and stowed positions.

FIG. 5 is a plan of the try square on a stile to be scribed.

FIG. 6 is a plan of the try square checking an external angle.

FIG. 7 is a side view of a variant tab.

FIG. 8 is a end view of FIG. 7.

### DETAILED DESCRIPTION WITH RESPECT TO THE DRAWINGS

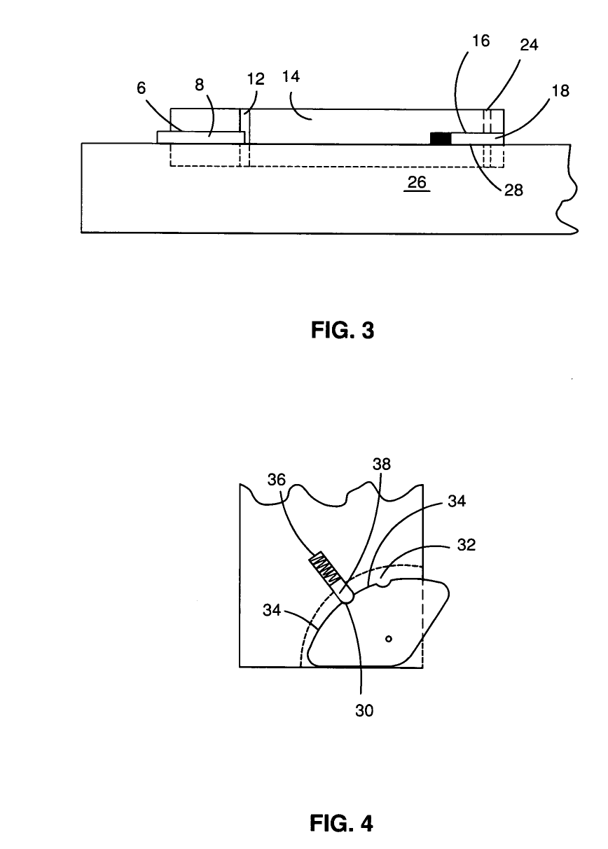

Referring now to the drawings, the brass stock 2 measures 143.5 mm×37 mm×15 mm and has at the blade end 4 a central slot 6 (see FIG. 3) which houses one end of stainless steel blade 8. The slot is 3.175 mm wide and the blade is fixed to the stock by five pins 10 at 90° thereto. A scribe groove 12 crosses the side 14 of the stock at the site where the blade and stock join.

In FIGS. 2 and 3, the opposite end of the stock also has a central slot 16 of the same width as blade slot 6. The slot is of quadrant shape in plan in order to accommodate a substantially rhombic tab 18 made of stainless steel of slightly less thickness than the width of slot 16. The central part of the slot remains within the stock while the arcuate ends 20, 22 project one at a time such that when end 22 projects, 20 lies within the stock. This is made possible by mounting the tab on a steel pivot pin 24, which is a press fit in a bore in the stock. The tab projects about 7 mm from side 14.

Thus when the square is laid on a timber stile 26 with the blade 8 lying across the stile as shown in FIG. 3, the arcuate end 20 projects and supports the stock such that the tab surface 28 and the corresponding surface of the blade 8 are coplanar. Thus the square is self-supporting.

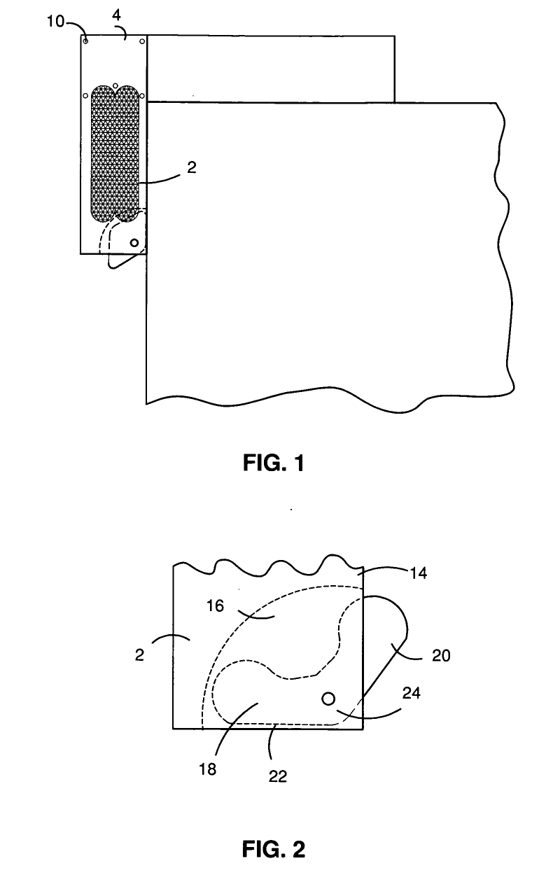

The scribing operation is reliable because the square is pressed down on the stile instead of being held by the stock in a position judged to be flat on the stile. When the square is to be used as shown in FIG. 1, the arcuate end 22 tilts inwards causing arcuate end 20 to project from the stock.

In FIG. 4, the rhombic tab is substituted by a substantially sector shape with a pair of notches 30, 32 cut into the curved edge 34. Spring 36 urges detent 38 into the notches.

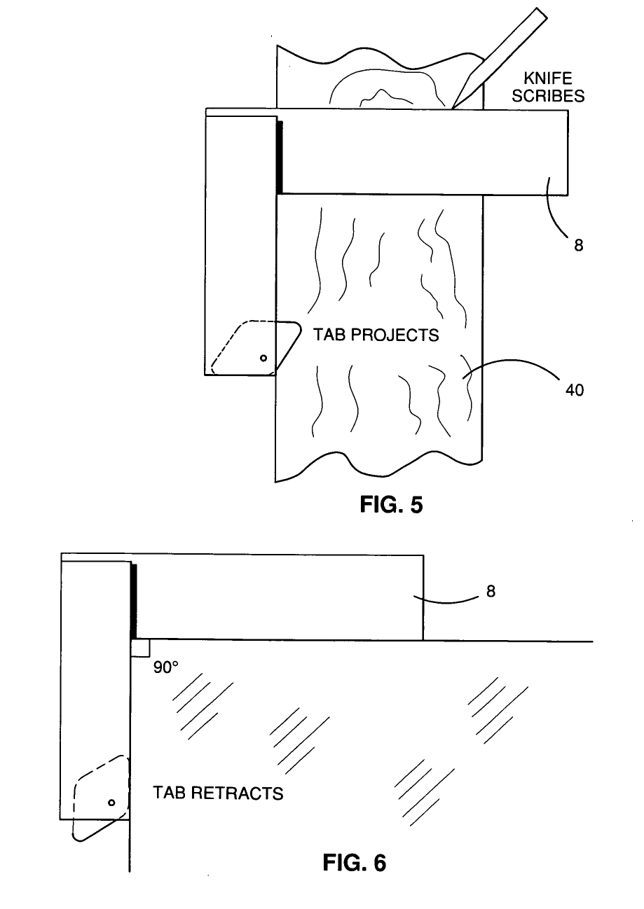

FIGS. 5 and 6 show the try square in use, the surface 40 of the side being the target surface.

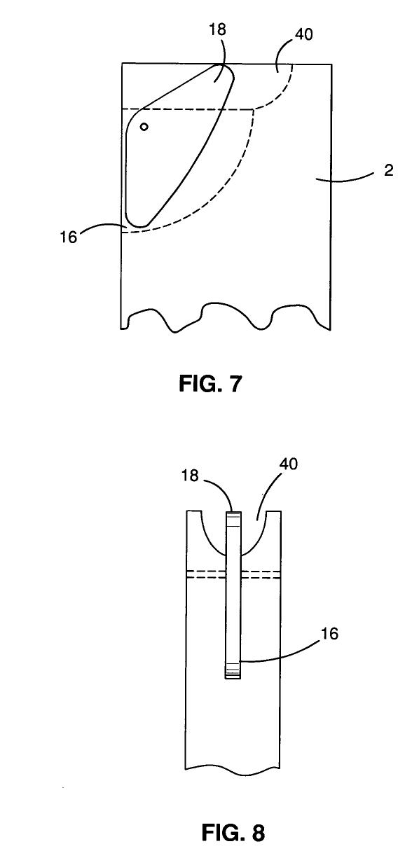

Referring now to FIGS. 7 and 8, a central slot 16 accommodates a triangular tab 18 with rounded ends. The end of the stock is milled to form a cavity 40 which admits the end of the users finger, in order to displace the tab 18 into a support position but in the stowed position the tab lies completely within the stock.

It is to be understood that the word “comprising” as used throughout the specification is to be interpreted in its inclusive form, ie. use of the word “comprising” does not exclude the addition of other elements.

It is to be understood that various modifications of and/or additions to the invention can be made without departing from the basic nature of the invention. These modifications and/or additions are therefore considered to fall within the scope of the invention.

What is claimed is:

1. A try square comprising a straight stock with a pair of parallel edges, an upper face, a blade end and an opposite support end, a blade extending perpendicular from one of the parallel edges at the blade end of the stock, the blade having a top face and a bottom face, a tab housing at the opposite support end, a tab with a top face and a bottom face mounted in the housing and moveable from a stowed position clear of the parallel edge from which the blade projects to a support position alongside the blade in which the bottom face of the tab projects and lies coplanar with the bottom face of the blade so that both are operable to contact a common target surface, but the tab supports the stock as it rests on the target surface.

2. A try square as claimed in claim 1, wherein the tab housing is a cavity which opens on to the one parallel edge.

3. A try square as claimed in claim 2, wherein the tab is pivotally mounted in the housing and describes arcuate movement between the stowed position and the support position.

4. A try square as claimed in claim 3, wherein the tab is substantially rhomb shaped in plan.

5. A try square as claimed in claim 1, wherein the tab projects from the opposite support end when the tab is in the stowed position and is displaceable to the support position by finger pressure.

6. A try square as claimed in claim 3, wherein the tab is substantially sector shaped in plan.

7. A try square as claimed in claim 6, wherein the tab has a curved edge and the edge defines a pair of notches which are engaged by a detent carried in the stock adjacent the housing, the notches determining the projection of the tab.
